(19) United States
(12) Patent Application Publication
(10) Pub. No.: US 2026/0314546 A1
(43) Pub. Date: Oct. 15, 2026

(54) MARKING ELEMENT FOR TREE TRUNKS AND MARKING SYSTEM

(71) Applicant: Latschbacher GmbH, Kronstorf (AT)

(72) Inventor: Klaus LATSCHBACHER, Kronstorf (AT)

(21) Appl. No.: 19/643,439

(22) Filed: Apr. 9, 2026

(30) Foreign Application Priority Data
Apr. 9, 2025 (EP) 25169449.3

(51) Int. Cl. A01G 23/099

(52) U.S. Cl. CPC A01G 23/099

(57) ABSTRACT

A marking element for tree trunks, including a marking surface formed on a front side of a plate-shaped base body. At least two locking lugs project from the front side, which are formed for a form-fitting coupling with a hammer head of a driving hammer, in which the base body is traversed by a recess for receiving a fastening nail and which is bordered in some areas by a first end face of a first tongue connected to the base body, and in which the first end face of the first tongue borders at least 20 percent of the circumference of the recess.

This application claims the benefit of European application EP 25169449.3 filed Apr. 9, 2025, which is incorporated herein by reference.

The invention relates to a marking element for tree trunks and a marking system comprising such a marking element.

EP 1 607 926 B1 discloses a marking plate for marking tree trunks, comprising a flat body bearing a marking, which is provided with retaining means for attaching to a driving hammer, wherein a nail extends perpendicularly through the flat body, wherein the nail is held in a through-opening of the flat body in a clamping manner and can be displaced only by applying force, and the holding force of the retaining means is designed to be less than the displacement force of the nail through the through-opening, and wherein slits extend outward from the edge of the through-opening, thereby forming elastic tongues.

### SUMMARY

The objective of the invention is to provide a marking element for tree trunks as well as a marking system comprising such a marking element.

This problem is solved for a marking element of the aforementioned type in that the marking element comprises a marking surface formed on a front side of a plate-shaped base body, wherein at least two locking lugs project from the front side, which are designed for a form-fitting engagement (positive locking) with a hammer head of a driving hammer, wherein the base body is penetrated by a recess designed to accommodate a fastening nail and which is bordered in parts by a first end face of a first tongue connected to the base body, wherein the first end face of the first tongue borders at least 20 percent of the circumference of the recess.

The marking element serves for the long-term marking of living trees, for example to enable the unambiguous assignment of tree maintenance work performed, which must be carried out and documented by owners or municipalities on trees in parks or along roadways. Accordingly, the marking element must be designed to remain on the living tree for several years without impairing the tree’s health or running the risk of becoming embedded in or even overgrown by the tree’s growth.

Accordingly, unlike marking plates used for labeling sawn timber, the marking element is not fastened to the tree by blades attached directly to the marking element. Rather, the marking element is intended to be fastened using a nail that passes through a recess formed in the marking element and is driven through the tree’s bark into the trunk wood using a driving hammer. In this context, the nail and the recess in the marking element are designed to fit together such that the marking element can be slid along the nail with virtually no friction.

To ensure the simplest possible handling of the marking element and the associated nail, the marking element features, on a front side of a plate-shaped base body that can be used as a marking surface for printed markings or laser markings, at least two locking lugs, with which the marking element can be temporarily secured in a form-fitting manner to the head of a hammer. Preferably, the locking lugs each comprise a locking projection that projects toward a center of mass of the marking element, referred to simply as the center of gravity, and is configured for positive engagement with a circumferential groove on a lateral surface of the hammer head of the driving hammer.

Furthermore, it is provided that the recess in the marking element, which is intended to receive the nail, is bordered in some areas (partially) by a first end face of a first tongue. The tongue exhibits, at least in some areas, a lower moment of resistance to bending and thus greater flexibility than the main body of the marking element. The function of the tongue is such that, at the end of the marking element’s service life, when the nail has grown too far into the tree to secure the marking element and the tree’s bark is in contact with a rear surface of the marking element facing away from the front, the marking element can be pushed off the nail by elastic deformation of the tongue. The force which is required to push the marking element off the nail is very low, even though the marking element must pass the head of the nail. This avoids a covering of the marking element by the tree’s bark. To ensure this disengagement or detachment of the marking element from the nail, it is provided that a first end face of the first tongue, which partially borders the recess in the marking element, extends over at least 20 percent of the circumference of the recess in the marking element. To ensure that the desired detachment of the marking element from the nail can occur reliably, the use of a nail specifically adapted to the marking element is provided. In this regard, the cross-section of the nail head plays a particularly significant role; it must be neither too large nor too small. The design of the driving hammer used to drive the nail together with the marking element prevents the use of nails with excessively large nail heads.

Advantageous embodiments of the invention are the subject of the subclaims.

It is advantageous for the first tongue to be connected to the base body in a first connection zone, wherein a distance between the recess and the first connection zone is at least 1.5 times the diameter of the recess.

Preferably, the marking element is manufactured using a plastic injection molding process in which the first tongue is produced as a single piece with the base body. To ensure both advantageous release of the marking element from the nail at the end of the marking element’s service life and a reliable coupling of the marking element with the nail during the marking element’s service life, precise tuning of the elastic properties of the tongue is required. In addition to the material thickness of the tongue and its width, the length of the tongue plays a particularly significant role in this regard. This length can also be described as the distance between the first end face of the tongue, which partially borders the recess, and the first connection zone. This length is at least 1.5 times the diameter of the recess; if the recess does not have a circular cross-section, an average diameter of the recess may be used to determine the length of the tongue.

It is advantageous if the recess is bordered in some areas by a first end face of a first base body edge, wherein a distance from the first end face of the first base body edge to a center of gravity of the base body is greater than a distance from the first end face of the first tongue to the center of gravity of the base body. The primary function of the first end face of the first base body edge of the marking element is to, together with the first end face of the first tongue, border the recess in the marking element at least in certain areas, thereby ensuring force transmission between the marking element and the nail with the lowest possible surface pressure. Due to the greater distance that the first end face of the first base body edge has relative to the first end face of the first tongue from the center of gravity of the base body, it can be assumed that the marking element rests on the nail with the first base body edge, thereby ensuring the desired force transmission with low surface pressure. Although the marking element, which is only loosely mounted on the nail, may, for example due to wind influence, perform a pivoting movement about a longitudinal axis of the nail, during which a temporary force transmission from the first end face of the first tongue to the nail also occurs, this special situation typically occurs only rarely or only for short periods of time.

It is preferably provided that the first tongue is designed in the connection zone with a material thickness corresponding to the material thickness of the base body, and that the first tongue has a material thickness along a section, preferably shaped like a strip—extending between the connection zone and the recess, which corresponds to less than 60 percent of the material thickness of the base body. This profiling of the first tongue ensures advantageous force transmission from the first tongue to the base body in the connection zone. The connection zone is therefore not designed as a film hinge or solid-body joint, which would ensure particularly high flexibility of the first tongue relative to the base body. Rather, elastic deformation of the first tongue upon detachment of the marking element from the nail is provided in the region of a section, in particular a strip-like section, which extends adjacent to the connection zone up to just before the first end face of the first tongue. The flexibility of this section of the first tongue is determined by the section’s width, the section’s length, the section’s material thickness, and the material selection for the marking element. The section extending between the connection zone and the first end face can also be regarded as a bending beam, particularly as a bending beam with a constant cross-section. A plane of curvature in which a change in the cross-section of the first tongue may occur during a detachment process of the marking element from the nail is preferably oriented transversely to the distance between the center of gravity and the first edge of the base body. It is preferably provided that the reduction in material thickness for the section of the first tongue is provided starting from the front side of the base body so that the rear side of the base body and a rear side of the first tongue are aligned flush with one another.

In a further embodiment of the invention, the first tongue is provided with a reinforcement, which reinforcement is formed as a ring section which is located adjacent to the end face, wherein the material thickness of the reinforcement corresponds at least substantially (or is identical) to the material thickness of the base body. The purpose of the ring section is to ensure advantageous force transmission with low surface pressure between the nail and the first tongue when, for example, due to wind influence, a pivoting movement of the marking element occurs about a pivot axis that is aligned parallel to the distance between the center of gravity and the recess. By way of example, the reinforcement is formed as a section of a circular cylindrical ring.

In a further embodiment of the invention, a second tongue is provided that is attached to and configured on the base body in a mirror-symmetrical manner relative to the first tongue, such that a second end face of the second tongue borders at least 20 percent of the circumference of the recess. The second tongue facilitates the detachment of the marking element from the nail, as this detachment is made possible even with a spatial orientation of the marking element that, in the presence of a single tongue, might lead to a blockage of the detachment process. It is preferably provided that exactly two tongues are provided. It is particularly preferred that the second tongue be formed in a mirror-symmetrically identical manner to the first tongue and be arranged on the base body in a mirror-symmetrical manner relative to the first tongue. It is particularly preferred that the first end face of the first tongue and the second end face of the second tongue each border at least 30 percent of the circumference of the recess.

It is therefore advantageous if the recess is bordered, in particular exclusively, by the first end face of the first tongue, by the second end face of the second tongue, and by a first end face of a first base body edge. Preferably, the marking element is designed such that, without the influence of external forces such as wind forces, the center of gravity of the marking element is located vertically below the recess and the marking element rests on the nail with the first end face of the first base body edge, while the first end face of the first tongue and the second end face of the second tongue do not, or at least only to a very limited extent, participate in transferring the weight of the marking element to the nail. This ensures that even during prolonged use of the marking element, for example over several years, no deformation of the first tongue and the second tongue occurs due to continuous force application, so that even at the end of the marking element’s service life, they still possess the necessary flexibility to allow easy detachment of the marking element from the nail.

Preferably, it is provided that the recess bounded by the first end face of the first tongue, the second end face of the second tongue, and the first end face of the first base body edge has a cylindrical geometry. Preferably, an axis of extension for the cylindrical geometry is oriented transversely to the front face of the marking element, so that, without the application of external forces, the largest possible contact area of the first base body edge of the marking element on the nail is ensured. This ensures high load-bearing capacity for the coupling between the marking element and the nail, which can be regarded as a sliding bearing.

In an advantageous further embodiment of the invention, it is provided that the recess has a circular cross-section. Consequently, starting from an orientation in which the center of gravity lies vertically below the recess, the marking element can perform a free pivoting movement about a longitudinal axis of the nail when subjected to external forces, such as wind forces, without encountering undesirable resistance to movement. This prevents the marking element from becoming jammed in an unfavorable pivoting position relative to the nail and potentially causing an undesirable, sustained force to be applied to the first tongue or the second tongue, which could compromise the function of the first tongue and/or the second tongue in the long term.

It is advantageous if a first lower edge of the first tongue, facing the center of gravity of the base body and formed in particular as a straight line, and a second lower edge of the second tongue, facing the center of gravity of the base body and formed in particular as a straight line, are aligned transversely to a distance between the center of gravity of the base body and a center point of the recess.

In a further embodiment of the invention, it is provided that a first upper edge of the first tongue, which is directed away from the center of gravity of the base body and is in particular straight, and a second upper edge of the second tongue, which is directed away from the center of gravity of the base body and is in particular straight, are aligned in some regions transversely to a distance between the center of gravity of the base body and a center point of the recess.

It is advantageous if the first upper edge and the second upper edge, each adjacent to the recess, form an angle within an interval between 20 degrees and 60 degrees, in particular an angle of 45 degrees, with respect to the distance between the center of gravity of the base body and a center point of the recess, and that the first base body edge forms a support nose extending toward the center of gravity, which is designed with a wedge-shaped widening starting from the first end face of the first base body edge as the distance from the center of gravity increases. In this context, the chamfered sections on the first upper edge of the first tongue and on the second upper edge of the second tongue serve to provide space for the support nose formed on the first base body edge. The support nose, in turn, serves to ensure an advantageous force transmission from the first end face of the first base body edge to the remainder of the base body. To this end, the wedge-shaped widening of the support nose, which increases with distance from the center of gravity, is provided to enable an advantageous flow of force from the nail via the support nose into the base body.

It is advantageous if a second base body edge, opposite the first lower edge and the second lower edge, features a sector-shaped recess extending toward the center of gravity and aligned at least substantially coaxially with the recess, and is oriented parallel to the first lower edge and the second lower edge away from the recess. The recess facilitates the decoupling of the marking element from the nail during the elastic deformation of the first tongue and/or the second tongue and is intended to prevent the marking element from jamming on the nail during the disengagement process.

The marking element according to the invention may comprise a nail received in the recess of the marking element, preferably made of a metallic material, in particular steel or aluminum, wherein the nail comprises a nail shaft, a nail head arranged at a first end of the nail shaft, and a nail tip arranged a second end of the nail shaft facing away from the nail head, and wherein the nail head faces the front side of the plate-shaped base body.

A marking system comprises the marking element in combination with the nail according to the invention and further comprises a driving hammer with a hammer head, which has a flat striking surface designed to contact the front side of the plate-shaped base body of the marking element, and which hammer head is provided with an insertion groove oriented transversely to the striking surface for receiving the nail, wherein the insertion groove is associated with a spring-elastic retaining clip designed to secure the nail in the insertion groove by a form-fit. When using nails made of iron, particularly steel, it may be provided that at least one permanent magnet is arranged in the insertion groove in the hammer head. This allows the nail to be held in the insertion groove by the attractive force of the permanent magnet until the driving process is complete and the driving hammer can be released from the nail, which is now embedded in the wood, by a pivoting movement. When using nails made of aluminum or other non-magnetizable materials, this holding force, which can be achieved with a magnet, is not present. In this case, a spring-loaded retaining clip is provided on the hammer head, which performs an elastic deflection movement when a nail is inserted into the insertion groove and subsequently holds the nail in the insertion groove until the driving process has been completed and the driving hammer is released from the nail now driven into the tree by the pivoting movement. It is understood that, even without equipping the hammer head with permanent magnets, the retaining clip can also secure steel nails in the insertion groove.

### BRIEF DESCRIPTION OF THE FIGURES

An advantageous embodiment of the invention is shown in the drawings. Here,

FIG. 1 shows a front view of a first embodiment of a marking element,

FIG. 2 shows a perspective view of the marking element according to FIG. 1,

FIG. 3 shows a rear view of the first embodiment of the marking element,

FIG. 4 shows a rear view of a second embodiment of a marking element,

FIG. 5 shows a perspective view of a driving hammer for processing the marking element with an inserted nail, and

FIG. 6 shows a perspective view of a retaining clip for the driving hammer to secure the nail.

### DETAILED DESCRIPTION

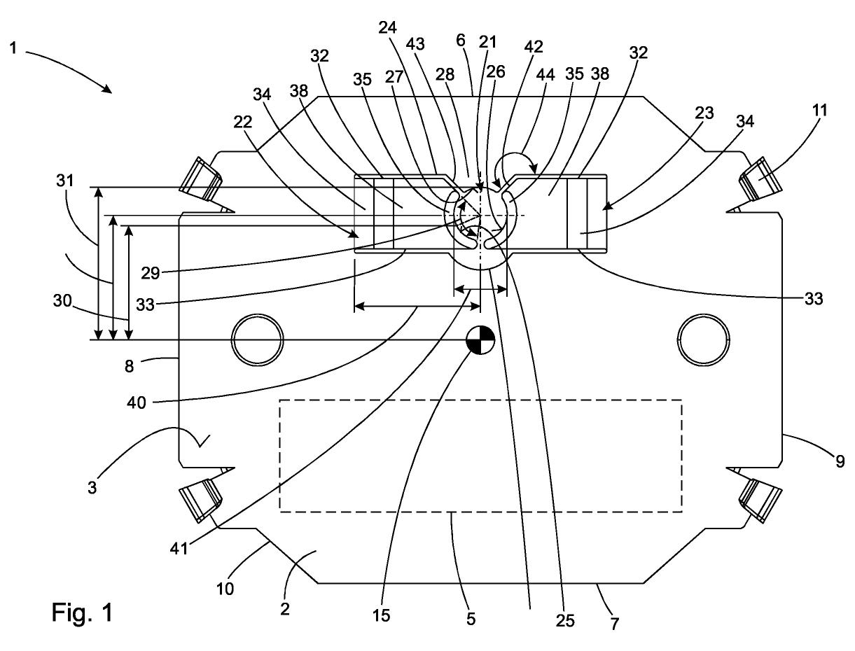

A marking element 1 shown in FIG. 1 is designed for marking living trees and is intended for use with a nail (not shown).

The marking element 1 comprises a plate-shaped base body 2, which is formed, purely by way of example, as a plane-parallel plate with an at least substantially flat front side 3 and an at least substantially flat rear side 4. Preferably, the marking element is made of a plastic, in particular a polycarbonate plastic or a polyamide plastic, and is manufactured using a plastic injection molding process. On the front side 3, purely by way of example, a labeling surface 5 is depicted, on which, for example, printing or laser labeling of the marking element 1 can be performed.

By way of example, the base body 2 is at least substantially rectangular in shape and has pairs of parallel outer edges 6, 7, 8, and 9. Deviating from a rectangular contour, the base body 2 has chamfered edges 10, each of which is associated with a locking lug 11.

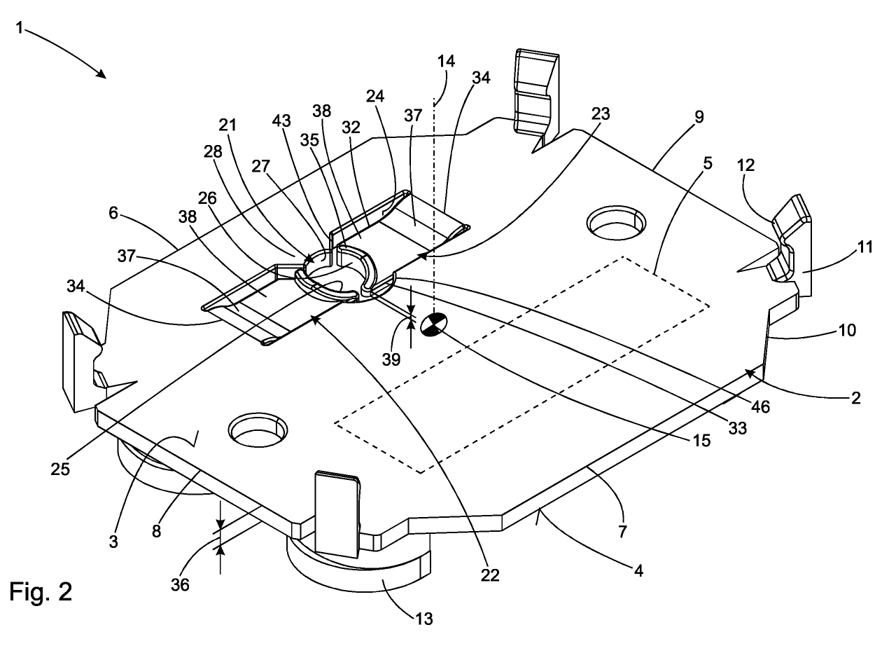

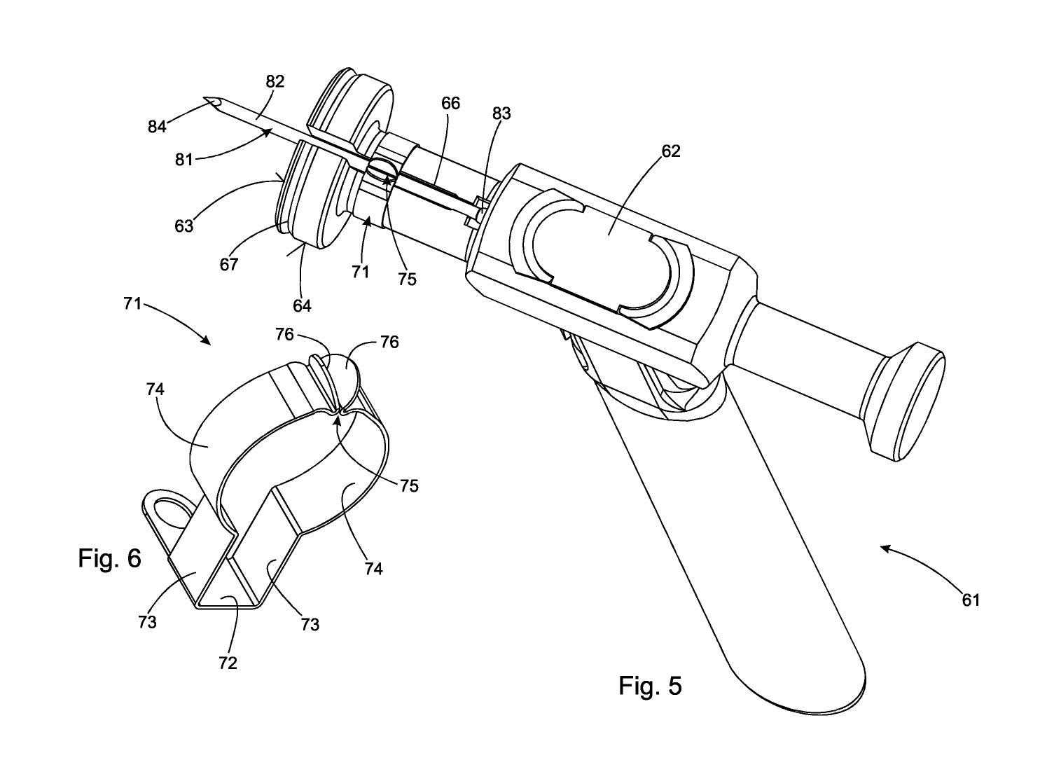

As can be seen from the depiction in FIG. 2, the locking lugs 11 extend from the front face 3, each parallel to a surface normal 14 of the front face 3. Each of the locking lugs 11 has a locking projection 12 that extends toward a volume center of mass of the marking element 1, shown only schematically hereinafter referred to as the center of mass 15. The locking lugs 11 are designed in a known manner for positive engagement (form fit) in a circumferential groove 67 of a driving hammer 51, as shown in FIG. 5 and described in more detail below.

As shown in FIGS. 2 and 3, double-S-shaped cutting edges 13 are formed on the rear side 4 of the base body 2 in a mirror-image arrangement relative to one another; these are irrelevant to the function of the marking element 1 and merely facilitate the manufacture of the marking element 1 and may be omitted. This is due to the fact that, apart from the geometry described in more detail below for receiving a nail, the marking element 1 is, at least in essence, structurally identical to conventional marking plates, such as those used for marking sawn timber, and for which, for example, a marking apparatus, in particular a laser marking apparatus, is available, which is also intended to be used for the marking element 1 according to the invention. In this context, the cutting edges 13 serve for positioning in the marking device; no further functions are associated with the cutting edges 13.

Unlike a conventional marking tag, the marking element 1 features a recess 21 that penetrates the base body 2 and is designed to accommodate a nail. The nail (not shown) creates a mechanical connection between the marking element 1 and a tree. Preferably, the nail is driven into the tree only over a portion of its length, for example approximately 30 percent of its length, and the marking element 1 can be slid along the nail with at least near-zero friction. The marking element 1 is designed to remain on the tree for an extended period of time, which may span several years. At the end of this service life, which may span several years, it must be ensured that the marking element 1 can be detached from the nail with as little damage as possible to the tree bark, which moves ever closer to the marking element 1 as the tree grows, in order to prevent the marking element 1 from becoming embedded in the tree bark.

To ensure these properties of the marking element 1, a range of external influences acting on the marking element must be taken into account. In particular, solar radiation, wind forces, vegetation growth, and ice or snow adhesion must be considered. These external influences can alter the material properties, for example through material embrittlement, and/or the geometric properties, for example through moss growth, of the marking element 1, whereby the design of the recess is intended to ensure that the basic functions of the marking element with regard to its ability to slide along the nail and its detachment at the end of its service life are not impaired.

As can be seen from the illustrations in FIGS. 1 through 3, the recess 21 is bounded by a first end face 25 of a first tongue 22, by a second end face 26 of a second tongue 23, and by a first end face 27 of a first body edge 25, which is formed in some areas as a support nose 28. By way of example, it is provided that the recess 21 bounded by the end faces 25, 26, and 27 has a circular cross-section. Furthermore, purely by way of example, it is provided that each of the end faces 26, 27, 28 is formed by a section of a lateral surface of a circular cylinder, such that the recess 21 is defined as a circular cylinder geometry.

The first end face 25 and the second end face 26 each extend over an angle 29 of slightly more than 120 degrees, such that each of the two end faces 25, 26 borders slightly more than 30 percent of the circumference of the recess 21.

A center point of the first end face 27 of the first base body edge 25, which is formed on the support nose 28, has a greater distance 31 from the center of gravity 15 than a center point of the first end face 25 of the first tongue 22, which has a distance 30 from the center of gravity 15. Furthermore, the first end face 27 is arranged centrally, specifically symmetrically with respect to the distance 31. As a result, a weight force to be transmitted from the marking element 1 to the nail received in the recess 21 is, as a rule, applied to the nail exclusively via the support nose 28. The function of the two tongues 22, 23 is to prevent the marking element 1 from detaching from the nail until the tree bark exerts a sufficiently large force on the marking element 1, causing the marking element 1 to detach from the nail.

The two tongues 22, 23 are designed to be mirror-symmetrical with respect to the gap 31, so that only the geometric properties of the first tongue 22 are described below; however, these apply equally to the second tongue 23.

The first tongue 22 is, for example strip shaped. By way of illustration, an upper edge 32 of the first tongue 22 and a lower edge 33 of the first tongue 22 are each straight and parallel to one another. The first tongue 22 is integrally connected to the base body 2, whereby a connecting zone 34 is created for this purpose, from which a tapering of the first tongue toward the recess 21 is initially provided, in order to exhibit a ring-shaped reinforcement in the immediate vicinity of the recess 21, which is intended to enlarge the first end face 25 of the first tongue 22.

As can be seen from the depiction in FIG. 3, the first tongue 22 and the second tongue 23 are formed on the rear side 4 of the base body 2 so as to be flush with the remainder of the rear side 4, which is shown here purely by way of example as being flat.

As shown in FIGS. 1 and 2, the first tongue 22 has a material thickness at the connection zone 34 that corresponds to a material thickness 36 (thickness) of the base body 2. Starting from the connecting zone 34 in the direction of the recess 21, the first tongue 22 initially has a wedge-shaped taper 37, followed by a rib section 38 with a constant material thickness 39. By way of example, it is provided that the material thickness 39 is less than 60 percent of the material thickness 36 of the base body 1.

The first tongue 22 is designed such that a distance 40 between a center point of the recess 21 and the connecting zone 34 is equal to twice the diameter 41 of the recess 21, whereby the first tongue 22 has a length that, despite the dimensionally stable connection of the first tongue 22 to the base body 2 in the connection zone 34, ensures an elastic deflection movement to decouple the marking element 1 from the nail.

The first tongue 22 is provided with a chamfer 42 at the upper edge 32 to provide the installation space for the support nose 28. The support nose 28 is formed to widen in a wedge shape starting from the first end face 27, ensuring an advantageous transfer of force from the nail to the base body 2, whereby a counterforce corresponding to the weight of the marking element 1 can be applied to the marking element 1. A side surface 43 of the support nose 28 forms, purely by way of example, an angle 44 of 135 degrees with a section of the first base body edge 24 located away from the support nose 28. This prevents undesirable notch stresses when force is transmitted from the nail to the support nose 28, thereby enhancing the load-bearing capacity and durability of the marking element.

To facilitate advantageous decoupling of the marking element 1 from the nail, a second base body edge 45, opposite the first lower edge 33 and the second lower edge 33, is provided with a circular-segment-shaped recess 46. Preferably the circular-segment-shaped recess 46 is oriented coaxially to the recess 21.

Preferably, the nail is provided with a nail head whose diameter corresponds approximately to an outer diameter 47 of the reinforcements 35. With such a dimensioning of the nail, during the detachment of the marking element 1 from the nail, a displacement of the marking element 1 in the vertical direction upward occurs due to the rigid design of the support nose 28, such that the recess 46 ensures the necessary clearance for the nail head during the flexible deformation of the two tongues 22 and 23.

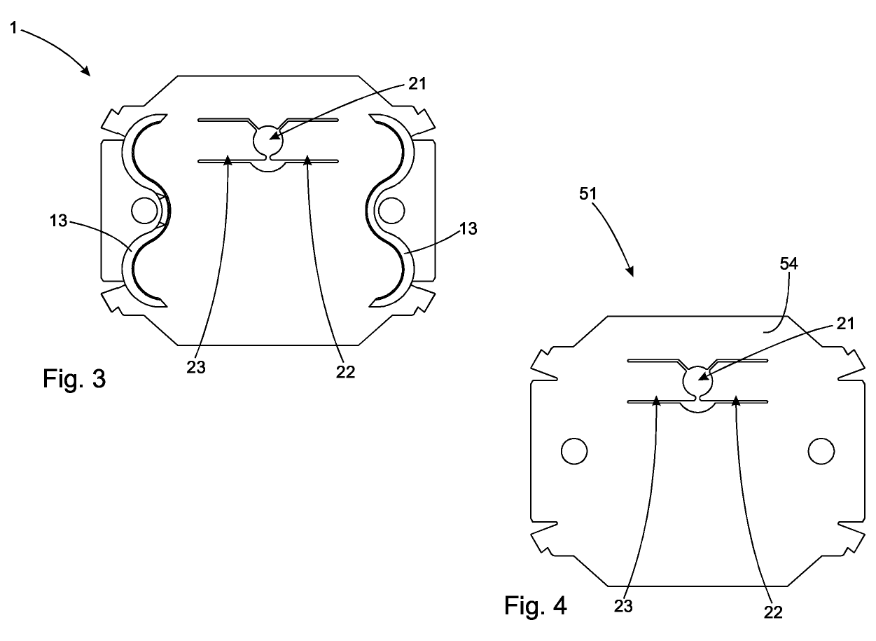

While in the first embodiment of the marking element 1 according to FIGS. 1-3, the cutting edges 13 are arranged in a mirror-symmetrical manner relative to one another on the rear side 4 of the base body 2, a second embodiment of a marking element 51 shown in FIG. 4 has no cutting edges on its rear side 54. In all other respects, the marking element 51 is designed identically to the marking element 1.

The driving hammer 61 shown in FIG. 5 has a design known from the applicant’s product range. The known driving hammer 61 is supplemented by the retaining clip 71 shown in FIG. 6, which ensures that a nail 81 is held in place by a form-fit in an insertion groove 66. The insertion groove 66 is aligned with a striking surface 63 formed on the hammer head 62 such that a nail 81 received therein protrudes perpendicularly across the striking surface 63. During a removal operation for a marking element 1 from a magazine (not shown) in which a plurality of marking elements is held, the circular cylindrical outer circumferential surface 64 achieves centering of the hammer head 62 relative to the marking element 1 in the magazine. Furthermore, a centering pin, not visible in FIG. 5, which projects radially outward from the underside of the outer circumferential surface 64 opposite the insertion groove 66, causes a rotational orientation of the hammer head 62 relative to the magazine, which features a longitudinal slot corresponding to the centering pin. Accordingly, the nail shaft 82 penetrates with the nail tip 84 into the respective recess 21 of the marking element 1, and the locking lugs 11 can engage in the circumferential groove 67 on the hammer head 62. Subsequently, during a retraction movement of the hammer head 62 from the magazine, the respective marking element can be removed and, in a subsequent step, driven together with the nail 81 into the bark and the trunk of a tree.

The retaining clip 71 is used in particular when the nail 81 is made of a non-magnetizable material such as aluminum, so that the permanent magnets (not shown) which are arranged below the insertion groove 66 in the known driving hammer 61 cannot reliably hold the nail 81 in place. If permanent magnets are omitted from the hammer head, nails made of magnetizable materials such as iron and steel can also be held in place by the retaining clip purely mechanically (by form fit).

The retaining clip 71 has a strip-shaped base section 72, which is provided at one end with a bore that is penetrated by the centering pin when the retaining clip 71 is attached to the hammer head 62, thereby preventing the retaining clip 71 from shifting along the hammer head 62.

Extending from the base section 72 are two parallel connecting sections 73, followed by two oppositely curved, essentially semicircular clamp sections 74 that define a feed slot 75. To ensure convenient insertion of a nail 81 into the insertion groove 66, end sections 76 adjoining the clamp sections 74 are formed with a chamfer relative to the respective clamp sections 74. This creates a wedge-shaped feed geometry that tapers toward the feed gap 75. When using the driving hammer 61 in conjunction with a nail 81, it may be provided, for example, to first place the nail 81 on the end sections 76 and then press the nail 81 into the insertion groove 66 while the retaining clip 71 undergoes elastic deformation. After the nail 81 has passed through the feed slot 75, the elastic recovery of the retaining clip 71 causes the desired form-fitting retention of the nail 81 in the insertion groove 66.

1. A marking element for tree trunks, comprising:
a marking surface formed on a front side of a plate-shaped base body,
wherein at least two locking lugs project from the front side, which are formed for a form-fitting coupling with a hammer head of a driving hammer,
wherein the base body is traversed by a recess for receiving a fastening nail and which is bordered in some areas by a first end face of a first tongue connected to the base body,
wherein the first end face of the first tongue borders at least 20 percent of the circumference of the recess.

2. The marking element according to claim 1, wherein the first tongue is connected to the base body in a first connection zone, wherein a distance between the recess and the first connection zone is at least 1.5 times a diameter of the recess.

3. The marking element according to claim 1, wherein the recess is bordered in some areas by a first end face of a first base body edge, wherein a distance from the first end face of the first base body edge to a center of gravity of the base body is greater than a distance of the end face of the first tongue to the center of gravity of the base body.

4. The marking element according to claim 1, wherein the connection zone of the first tongue is provided with a material thickness corresponding to a material thickness of the base body, and that the first tongue has a material thickness along a section has a material thickness which is less than 60 percent of the material thickness of the base body.

5. The marking element according to claim 4, wherein the first tongue has a reinforcement formed as a ring section adjacent to the first end face, wherein a material thickness of the reinforcement corresponds at least substantially to the material thickness of the base body.

6. The marking element according to claim 1, wherein a second tongue is attached to the base body in a mirror-symmetrical manner relative to the first tongue, such that a second end face of the second tongue borders at least 20 percent of the circumference of the recess.

7. The marking element according to claim 6, wherein the recess is bordered by the first end face of the first tongue, by the second end face of the second tongue, and by a first end face of a first base body edge.

8. The marking element according to claim 7, wherein the recess, bounded by the first end face of the first tongue, the second end face of the second tongue, and the first end face of the first base body edge, has a cylindrical geometry.

9. The marking element according to claim 8, wherein the recess has a circular cross-section.

10. The marking element according to claim 6, wherein a first lower edge of the first tongue, which faces the center of gravity of the base body and a second lower edge of the second tongue, which faces the center of gravity of the base body, are aligned transversely to a distance between the center of gravity of the base body and a center point of the recess.

11. The marking element according to claim 6, wherein a first upper edge of the first tongue, which is directed away from the center of gravity of the base body and a second upper edge of the second tongue, which is directed away from the center of gravity of the base body, are aligned in some regions transversely to a distance between the center of gravity of the base body and a center point of the recess.

12. The marking element according to claim 10, wherein the first upper edge and the second upper edge each form, adjacent to the recess, an angle within an interval between 20 degrees and 60 degrees with respect to the distance between the center of gravity of the base body and a center point of the recess, and that the first base body edge forms a support lug extending toward the center of gravity, which is designed to widen wedge-shapedly starting from the first end face of the first base body edge as the distance from the center of gravity increases.

13. The marking element according to claim 10, wherein a second base body edge opposite the first lower edge and the second lower edge comprises a sector-shaped recess extending toward the center of gravity at least substantially coaxial with the recess and is aligned parallel to the first lower edge and the second lower edge away from the recess.

14. The marking element according to claim 1, further comprising a nail having a nail shaft, a nail head arranged at a first end of the nail shaft, and a nail tip formed at a second end of the nail shaft opposite the nail head, wherein the nail head faces the front side of the plate-shaped base body and the nail shaft protruding the recess of the marking element.
